(19) United States
(12) Patent Application Publication
(10) Pub. No.: US 2002/0040831 A1
(43) Pub. Date: Apr. 11, 2002

(54) Elevator with drive unit supported by guide rail

(75) Inventors: Shigeo Nakagaki, Saitama-ken (JP); Yasuyuki Wagatsuma, Saitama-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/020,910

(22) Filed: Dec. 19, 2001

Related U.S. Application Data
(63) Continuation of application No. 09/393,688, filed on Sep. 10, 1999, now abandoned.

(30) Foreign Application Priority Data
Sep. 10, 1998 (JP) H10-257182

(51) Int. Cl. B66B 7/02

(52) U.S. Cl. 187/408; 187/406

(57) ABSTRACT

An elevator including a movable unit configured to ascend and descend in an elevator shaft, a guide rail installed on the elevator shaft via a plurality of rail support members and configured to guide the movable unit, a cable configured to hang the movable unit, and a driving unit mounted on the guide rail and configured to move the movable unit up and down by driving the cable. At least two securing members fixes one of the rail support members is fixed to a wall of the shaft by securing members separated from each other by an interval in the vertical direction.

### CROSS REFERENCE TO RELATED APPLICATION

This application claims benefit of priority to Japanese Patent Application No. JP10-257182 filed Sep. 10, 1998, the entire contents of which are incorporated by reference herein.

### BACKGROUND OF THE INVENTION

### Field of the Invention

The present invention relates to an elevator with a driving unit having a traction sheave, which drives cables hanging a passenger cage, and more particularly to an elevator driving unit mounted on the upper portion of a guide rail for guiding the passenger cage or a counter weight balancing the cage.

### DESCRIPTION OF THE BACKGROUND

In recent years, elevators have been developed without a machine room (penthouse) disposed right above an elevator shaft of a building in order to economize the inside space of the building.

FIG. 1 shows such an elevator as disclosed in Japanese Patent No. 2593288. In this elevator, a driving unit 106 has cables 103 placed around a traction sheave 107 and is disposed at an upper portion of an elevator shaft. As shown in FIG. 1, the elevator includes a passenger cage 101 having a door 112, counter weight 102 balancing the cage 101, cables 103 hanging the cage 101 and the counter weight 102, car sheaves 104, a controller 108, a counter weight sheave 109, the driving unit 106, a pair of cage guide rails 110, and a pair of counter weight guide rails 111. The driving unit 106 is supported by fixed members 113 and 114 such as a steel frame of the building or the like.

To make this type of elevator as shown in FIG. 1 practicable, there are various problems. One of the problems is how to keep the strength of rail support members 30 shown in FIG. 2(a) for installing the cage guide rails 110 to the shaft wall.

FIG. 2(a) is a side view of one of the cage guide rails 110 of FIG. 1. FIG. 2(b) is a plan view of FIG. 2(a).

Each of the rail support members 30 is composed of a U-shaped bracket 1 and an L-shaped plate 2D.

The pair of cage guide rails 110 is installed in an elevator shaft 6 and respectively composed of a plurality of guide rails 5. The guide rails 5 are connected with each other in a straight line by connecting plates 7.

The closed ends of the brackets 1 are secured at designated positions to the guide rails 5. The plates 2D have vertically extending portions secured on a shaft wall 4 at intervals in the vertical direction, each by a pair of anchor bolts 3. Horizontally extending portions of the plates 2D are welded to the open ends of the brackets 1.

In a conventional elevator, in which a machine room (penthouse) is located above the shaft 6, since the driving unit having a traction sheave is installed on the machine room, the load of the driving unit itself, the load of the cage 101 including passengers, and the load of the counter weight 102 weigh substantially on the floor of the machine room. Thus, such heavy load does not weigh on the cage guide rails 110.

However, in case the driving unit is mounted on the cage guide rails 110 in order to dispense with the machine room, the heavy load as described above weighs on the cage guide rails 110, so that a big bending moment is applied to basal portions of the plates 2D. Further, since two anchor bolts 3 are arranged horizontally in a single line, the bending moment directly applies to the bolts 3 as a tensile force.

Moreover, since the driving unit is mounted on the cage guide rails 110, vibration of the driving unit is transferred to the shaft wall 4 via the cage guide rails 110, and may cause vibration and noise in resident rooms or somewhere in the building.

### SUMMARY OF THE INVENTION

Accordingly, one object of the present invention is to provide a novel elevator with a driving unit mounted on a guide rail which can securely support the driving unit.

Another object of the present invention is to provide a novel elevator with a driving unit mounted on the guide rail, which can prevent vibration and noise caused by the driving unit from being transferred to the shaft wall.

These and other objects are achieved according to the present invention by providing a new and improved elevator including a movable unit configured to ascend and descend in an elevator shaft, a guide rail installed on the elevator shaft via a plurality of rail support members and configured to guide the movable unit, a cable configured to hang the movable unit, a driving unit mounted on the guide rail and configured to move the movable unit up and down by driving the cable, and at least two securing members fixing one of the rail support members to a wall of the shaft and disposed separated from each other with an interval in the vertical direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic perspective view showing a conventional traction type elevator;

FIG. 2(a) is a side view of the mounting structure of a cage guide rail of FIG. 1;

FIG. 2(b) is a plan view of the cage guide rail of FIG. 2(a);

FIG. 3(a) is a side view of the mounting structure of a cage guide rail of a first embodiment of the present invention;

FIG. 3(b) is a top view of the cage guide rail of FIG. 3(a);

FIG. 4(a) is a side view of the mounting structure of a cage guide rail of a second embodiment of the present invention;

FIG. 4(b) is a top view of the cage guide rail of FIG. 4(a);

FIG. 5(a) is a side view of the mounting structure of a cage guide rail of a third embodiment of the present invention;

FIG. 5(b) is a top view of the cage guide rail of FIG. 5(a);

FIG. 6(a) is a side view of the mounting structure of a cage guide rail of a fourth embodiment of the present invention;

FIG. 6(b) is a top view of the cage guide rail of FIG. 6(a);

FIG. 7 is a side view of the mounting structure of a cage guide rail of a fifth embodiment of the present invention;

FIG. 8(a) is a side view of the mounting structure of a cage guide rail of a sixth embodiment of the present invention;

FIG. 8(b) is a top view of the cage guide rail of FIG. 8(a);

FIG. 9(a) is a side view of the mounting structure of a cage guide rail of a seventh embodiment of the present invention;

FIG. 9(b) is a top view of the cage guide rail of FIG. 9(a);

FIG. 10(a) is a side view of the mounting structure of a cage guide rail of an eighth embodiment of the present invention;

FIG. 10(b) is a top view of the cage guide rail of FIG. 10(a);

FIG. 11(a) is a side view of the mounting structure of a cage guide rail of a ninth embodiment of the present invention;

FIG. 11(b) is a top view of the cage guide rail of FIG. 11(a);

FIG. 12(a) is a side view of the mounting structure of a cage guide rail of a tenth embodiment of the present invention;

FIG. 12(b) is a top view of the cage guide rail of FIG. 12(a);

FIG. 13(a) is a side view of the mounting structure of a cage guide rail of an eleventh embodiment of the present invention;

FIG. 13(b) is a top view of the cage guide rail of FIG. 13(a);

FIG. 13(c) is a view of a damper member in the direction of the arrows A of FIG. 13(a);

FIG. 14(a) is a side view of the mounting structure of a cage guide rail of a twelfth embodiment of the present invention;

FIG. 14(b) is a top view of the cage guide rail of FIG. 14(a);

FIG. 15(a) is a side view of the mounting structure of a cage guide rail of a thirteenth embodiment of the present invention;

FIG. 15(b) is a top view of the cage guide rail of FIG. 15(a);

FIG. 16(a) is a side view of the mounting structure of a cage guide rail of a fourteenth embodiment of the present invention;

FIG. 16(b) is a top view of the cage guide rail of FIG. 16(a);

FIG. 17(a) is a side view of the mounting structure of a cage guide rail of a fifteenth embodiment of the present invention;

FIG. 17(b) is a top view of the cage guide rail of FIG. 17(a);

FIG. 18(a) is a side view of the mounting structure of a cage guide rail of a sixteenth embodiment of the present invention;

FIG. 18(b) is a top view of the cage guide rail of FIG. 18(a);

FIG. 18(c) is a view of a damper member in the direction of the arrows A of FIG. 18(a);

FIG. 19(a) is a side view of the mounting structure of a cage guide rail of a seventeenth embodiment of the present invention;

FIG. 19(b) is a top view of the cage guide rail of FIG. 19(a);

FIG. 20(a) is a side view of the mounting structure of a cage guide rail of an eighteenth embodiment of the present invention;

FIG. 20(b) is a top view of the cage guide rail of FIG. 20(a);

FIG. 21(a) is a side view of the mounting structure of a cage guide rail of a nineteenth embodiment of the present invention;

FIG. 21(b) is a top view of the cage guide rail of FIG. 21(a);

FIG. 22(a) is a side view of the mounting structure of a cage guide rail of a twentieth embodiment of the present invention;

FIG. 22(b) is a top view of the cage guide rail of FIG. 22(a);

FIG. 23(a) is a side view of the mounting structure of a cage guide rail of a twenty-first embodiment of the present invention;

FIG. 23(b) is a top view of the cage guide rail of FIG. 23(a);

FIG. 23(c) is a view of a damper member in the direction of the arrows A of FIG. 23(a);

FIG. 24(a) is a side view of the mounting structure of a cage guide rail of a twenty-second embodiment of the present invention; and

FIG. 24(b) is a top view of the cage guide rail of FIG. 24(a).

### DETAILED DESCRIPTION OF THE INVENTION

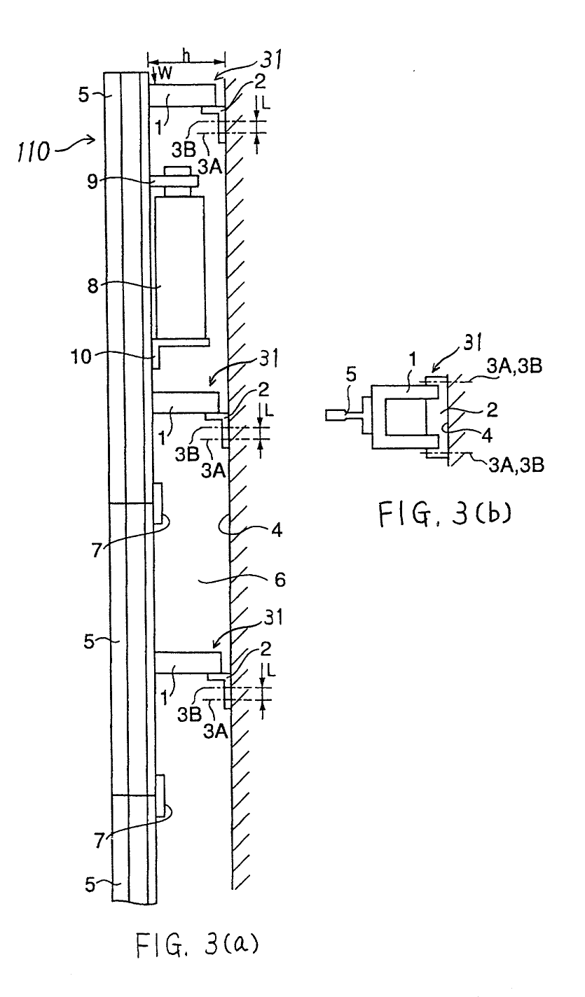

Referring now to the drawings, where like reference numerals designate the same or corresponding parts throughout the several views, there will be described a first embodiment of the present invention shown in FIGS. 3(a) and 3(b).

FIG. 3(a) is a side view of the mounting structure of a cage guide rail of a first embodiment of the present invention. FIG. 3(b) is a top view of the cage guide rail in FIG. 3(a).

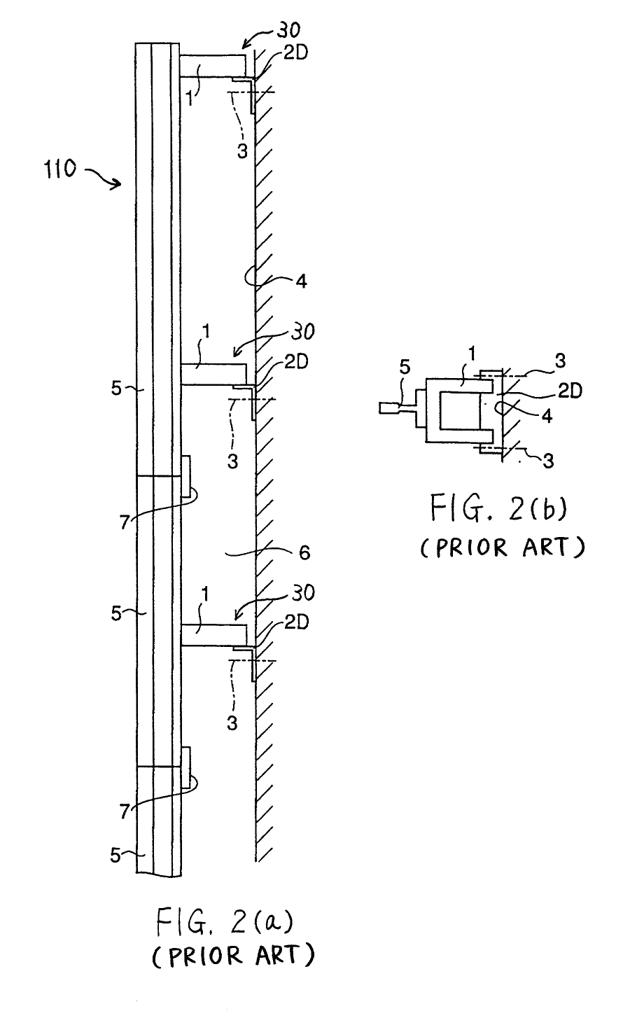

In this embodiment, a driving unit 8 is mounted one of the cage guide rails 110, and the mounting structure of the cage guide rail 110 is improved in comparison with the mounting structure of the cage guide rail 110 shown in FIG. 2.

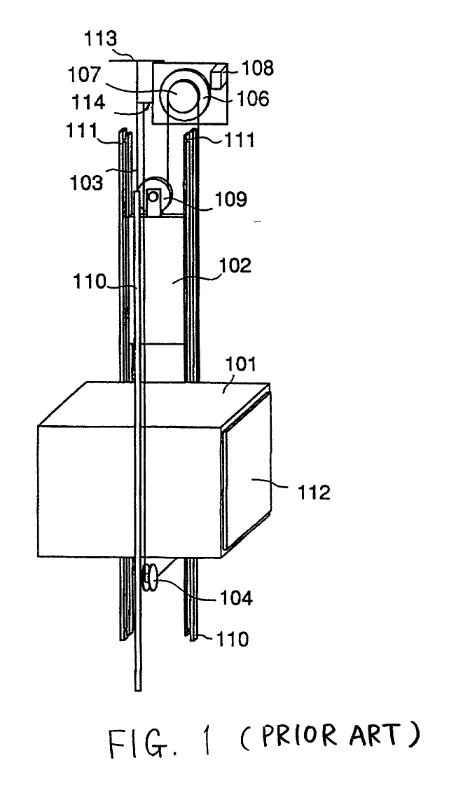

Similar to FIGS. 1 and 2, a pair of cage guide rails 110 (only one is shown in FIG. 3(a)) composed of plural rails 5 is installed on a shaft wall 4. One of the cage guide rails 110, on which the driving unit 8 mounted, is secured on the shaft wall 4 with rail support members 31 composed of brackets 1 having a U-shaped cross section and fastening plates 2 having a L-shaped cross section. The other cage guide rail 110 is secured on the shaft wall 4 by the rail support members 30 shown in FIG. 2. Further, a pair of counter weight guide rails 111 (not shown in FIG. 3(a)) is installed on the shaft wall 4 with the rail support members 30 shown in FIG. 2. The cage 101 and the counterweight 102 are respectively guided by the cage guide rails 110 and the counter weight guide rails 111, and hung by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured by the support base 10 and the bracket 9.

At least one of the fastening plates 2 is secured on the shaft wall 4 by two pairs of anchor bolts 3A and 3B separated by an interval in the horizontal direction. The anchor bolts 3A and 3B of each pair are separated by an interval in the vertical direction.

Closed ends of the brackets 1 are secured to the cage guide rail 110 with rail clips (not shown), and the opposite open ends thereof are respectively welded to the fastening plates 2.

Accordingly, in case that the sum load of the driving unit 8, the cage 101 including passengers, and the counter weight 102 weigh on the cage guide rail 110 vertically, the load is shared and supported by the respective rail support members 31.

As for one of the rail support members 31, h is a distance between the cage guide rail 110 and the shaft wall 4, W is a load applied to the junction of the cage guide rail 110 and the bracket 1, and M₁ is a bending moment working at the junction of the fastening plate 2 and the shaft wall 4.

M₁ is changeable according to a connecting structure of the junction of the cage guide rail 110 and the bracket 1. If the connecting structure is a pivot connection, that is, a vertical displacement of the cage guide rail 110 is restricted, but a pivot movement on the junction of the cage guide rail 110 and the bracket 1 is not restricted, M₁ will be calculated as follows.

M₁=Wh (1)

If the connecting structure is a rigid connection, that is, both the vertical displacement of the cage guide rail 110 and the pivot movement are restricted, M₁ will be calculated as follows.

M₁=Wh/2 (2)

On the other side, since the anchor bolts 3A and 3B are disposed each other with an interval in the vertical direction, the anchor bolts 3A function as a fulcrum and the anchor bolts 3B can receive the bending moment M₁. Thus, in case that L is a distance of the interval of the anchor bolts 3A and 3B, n is the number of the anchor bolts per line, and F is a tensile force applied to the anchor bolts 3B, a bending moment M₂ applied to the anchor bolts 3B are represented by equation (3):

M₂=LFn (3)

Further, assuming that f is a maximum permissible tensile strength of the anchor bolts 3B, and M₁ equals M₂, the minimum length of L is calculated by substituting f for F of equation (3), and represented by equations (4) and (5):

(In case of the pivot connection)

Lₘᵢₙ=(Wh)/(fn) (4)

(In case of the rigid connection)

Lₘᵢₙ=(Wh)/(2fn) (5)

Lₘᵢₙ shown in equations (4) and (5) are the minimum lengths of the interval between anchor bolts 3A and 3B as described above for pivot connections and rigid connections, respectively. Accordingly, as long as an interval L of the anchor bolts 3A and 3B is longer than the length Lₘᵢₙ, the strength of the rail support members 31 is surely kept safe. On the other hand, if an interval L of the anchor bolts 3A and 3B greatly exceeds the length Lₘᵢₙ, the fastening plates 2 become impractically large.

In the above description, although the minimum length Lₘᵢₙ is calculated in case of both the pivot connection and the rigid connection, practically a connecting structure of the junction of the cage guide rail 110 and the bracket 1 is considered as a compromise between the pivot connection and the rigid connection. Thus, a proper design of the length L can be achieved by setting the length Lₘᵢₙ calculated by equation (4) as an upper limit, and setting the length Lₘᵢₙ calculated by equation (5) as an lower limit. That is, the length L can be designed by using the following equation (6).

(Wh)/(2fn)≦L<(Wh)/(fn) (6)

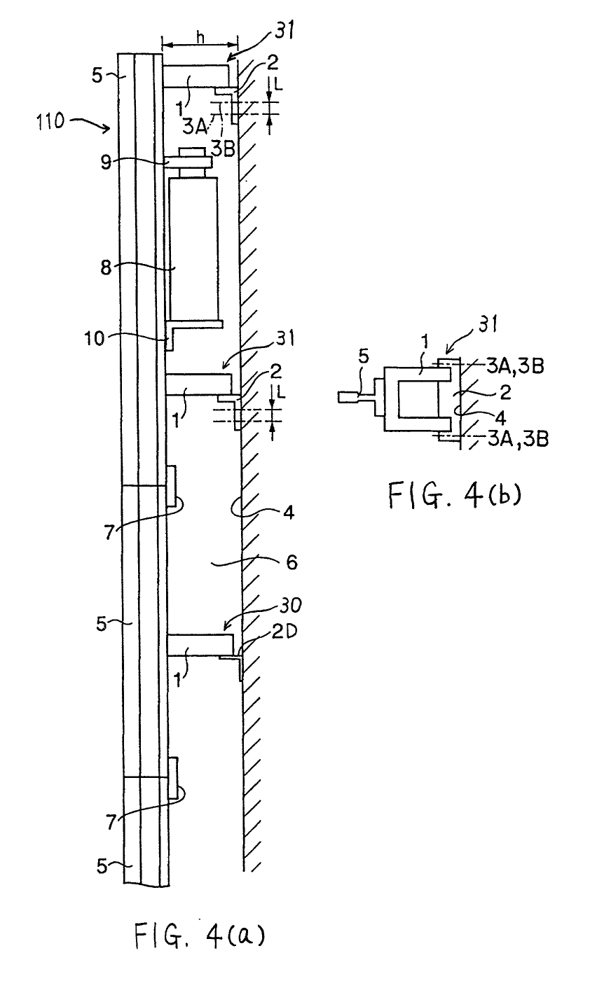

FIG. 4(a) is a side view of the mounting structure of a cage guide rail of a second embodiment of the present invention. FIG. 4(b) is a top view of the cage guide rail in FIG. 4(a).

Since the second embodiment modifies a part of the elevator of the first embodiment of the present invention, in the following description, only components different from the components explained in the first embodiment are described.

In the second embodiment, the support members 31 are used to support only the rail 5 on which the driving unit 8 is mounted. That is, the fastening plates 2 located adjacent to upper and lower sides of the driving unit 8 are secured on the shaft wall 4 with the two pairs of anchor bolts 3A and 3B in the same way as the first embodiment. The other rails 5 are secured with the rail support members 30 shown in FIG. 2.

According to the second embodiment, since only the rail 5 mounting the driving unit 8 is secured with the rail support members 31, the driving unit 8 can be surely supported with minimum structure.

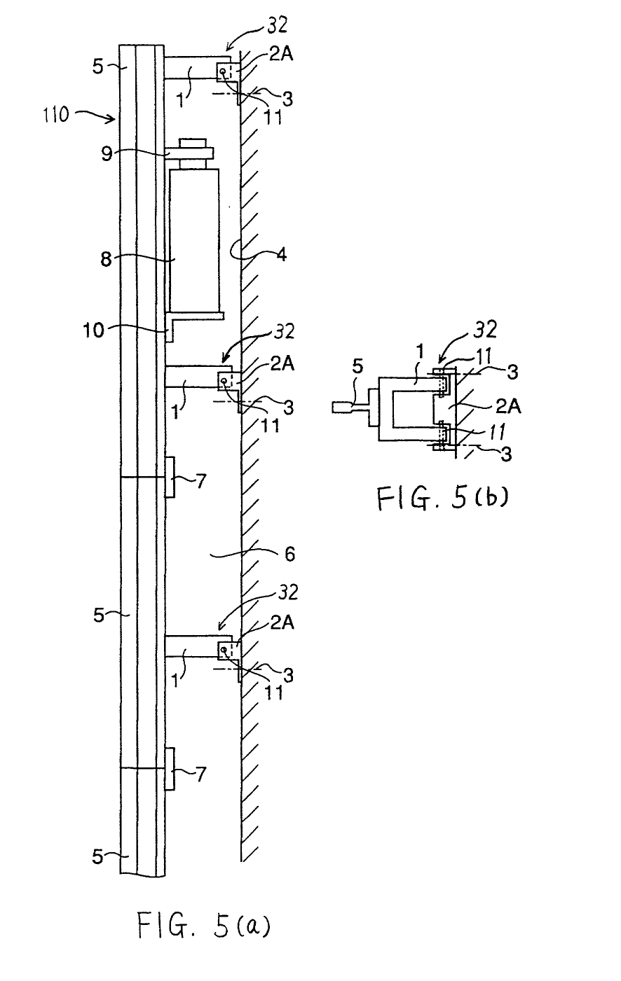

FIG. 5(a) is a side view of the mounting structure of a cage guide rail of a third embodiment of the present invention. FIG. 5(b) is a top view of the cage guide rail in FIG. 5(a).

In the third embodiment, a driving unit 8 is mounted on one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 5(a)) composed of plural rails 5 is installed on a shaft wall 4. One of the cage guide rails 110, on which the driving unit 8 is mounted, is secured on the shaft wall 4 with rail support members 32 composed of brackets 1 having a U-shaped cross section, fastening plates 2A having an L-shaped cross section, and pins 11. The other cage guide rail 110 is secured on the shaft wall 4 with the rail support members 30 shown in FIG. 2. Further, a pair of counter weight guide rails 111 (not shown in FIG. 5(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured with the support base 10 and the bracket 9.

Each of the rail support members 32 is composed of a bracket 1, a fastening plate 2A and a pin 11. The closed end of the bracket 1 is secured to the cage guide rail 110, and its opposite open ends are pivotably connected to the fastening plate 2A with a pin 11. The fastening plate 2A is fixed on the shaft wall 4 with two anchor bolts 3 disposed each other with an interval in the horizontal direction.

According to the third embodiment, since the open ends of the brackets 1 are pivotably connected to the fastening plates 2A, a bending moment working at a junction of the fastening plate 2A and the shaft wall 4, which is caused by a downward force applied to the cage guide rail 110, can be reduced.

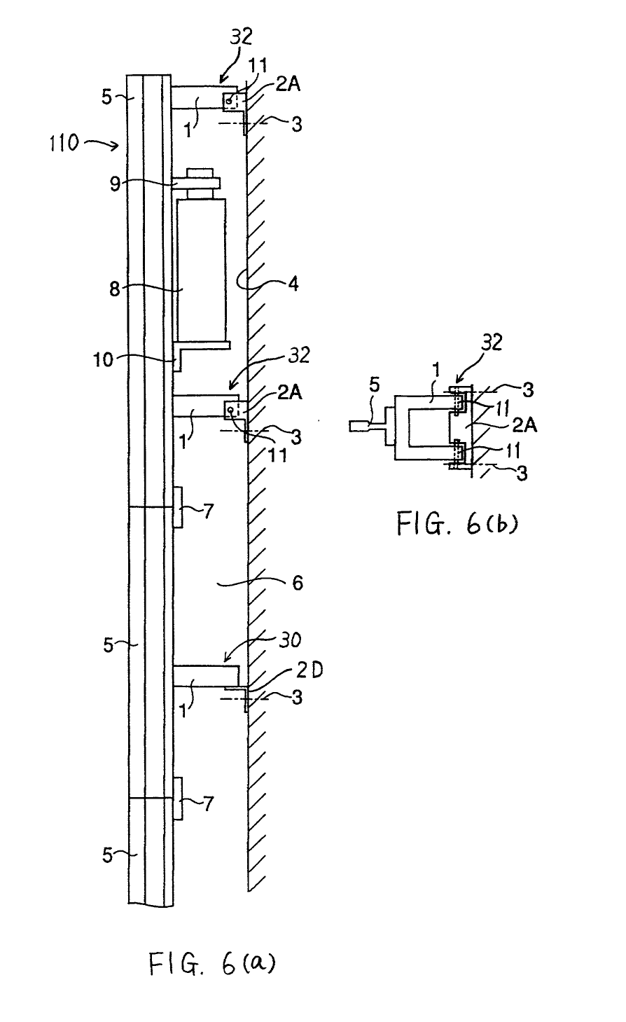

FIG. 6(a) is a side view of the mounting structure of a cage guide rail of a fourth embodiment of the present invention. FIG. 6(b) is a top view of the cage guide rail in FIG. 6(a).

Since the fourth embodiment modifies a part of the elevator of the third embodiment of the present invention, in the following description, only components different from the components explained in the third embodiment are described.

In the fourth embodiment, the support members 32 are arranged to support only the rail 5 mounting the driving unit 8. That is, the fastening plates 2A located adjacent to upper and lower sides of the driving unit 8 are secured on the shaft wall 4 in the same way as in the third embodiment. The other rails 5 are secured with the rail support members 30 shown in FIG. 2.

According to the fourth embodiment, since only one of the rails 5 mounting the driving unit 8 is secured with the rail support members 32, the driving unit 8 can be surely supported with minimum structure.

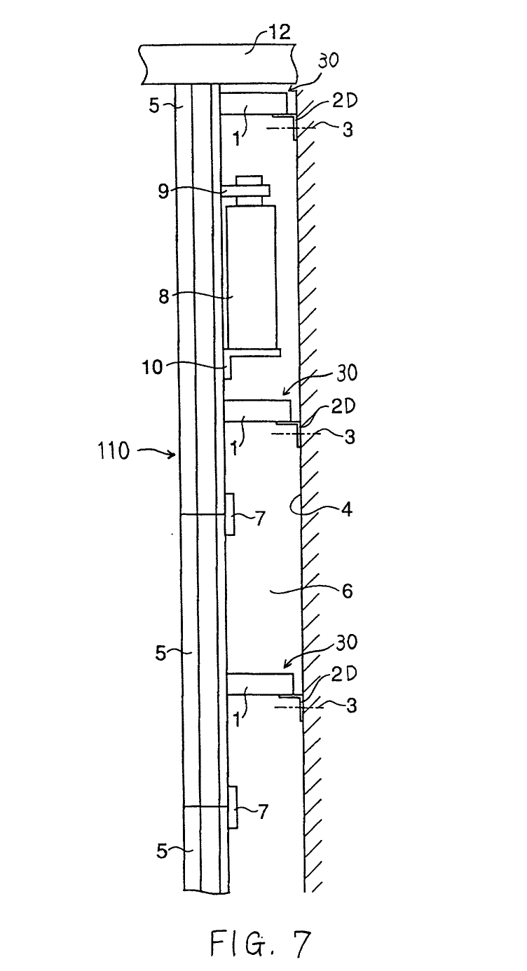

FIG. 7 is a side view of the mounting structure of a cage guide rail of a fifth embodiment of the present invention.

In the fifth embodiment, a driving unit 8 is mounted on one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 7) composed of some rails 5 is installed on a shaft wall 4 with the rail support members 30. As shown in FIG. 7, an upper end of one of the cage guide rails 110 mounting the driving unit 8 is secured on a beam 12 fixed on the elevator shaft 6. Further, a pair of counter weight guide rails 111 (not shown in FIG. 7) is installed on the shaft wall 4 with the rail support members 30 in the same way. The cage 101 and the counterweight 102 are respectively guided by the cage guide rails 110 and the counter weight guide rails 111, and hanged by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured with the support base 10 and the bracket 9.

According to the fifth embodiment, since one end of the cage guide rail 110, on which the driving unit 8 is mounted, is secured on the beam 12, a bending moment working at a junction of the fastening plate 2D and the shaft wall 4, which is caused by a downward force applying to the cage guide rail 110, can be reduced.

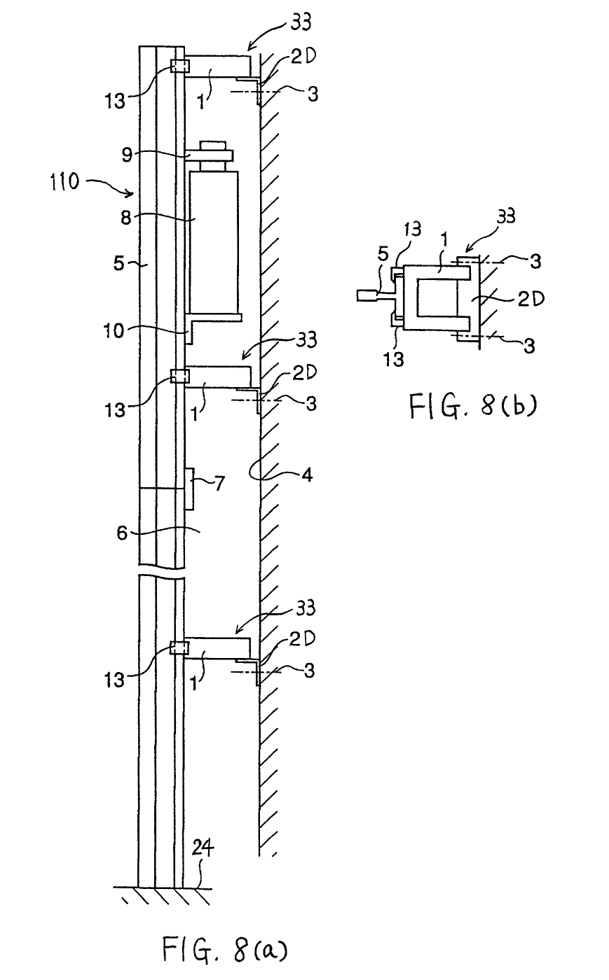

FIG. 8(a) is a side view of the mounting structure of a cage guide rail of a sixth embodiment of the present invention. FIG. 8(b) is a top view of the cage guide rail in FIG. 8(a).

In the sixth embodiment, a driving unit 8 is mounted on one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 8(a)) composed of plural rails 5 is installed on a shaft wall 4. One of the cage guide rails 110, on which the driving unit 8 is mounted, is secured on the shaft wall 4 with rail support members 33 composed of brackets 1 having a U-shaped cross section, clips 13, and fastening plates 2D having an L-shaped cross section, and stands on the bottom 24 of the shaft 6. The other cage guide rail 110 is secured on the shaft wall 4 with the rail support members 30 shown in FIG. 2. Further, a pair of counter weight guide rails 111 (not shown in FIG. 8(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured with the support base 10 and the bracket 9.

Each of the rail support members 33 is composed of a bracket 1, two clips 13 and a fastening plate 2D. The closed end of the bracket 1 is slidably secured to the cage guide rail 110 with the clips 13, and the opposite open ends thereof are connected to the fastening plate 2D. The fastening plate 2D is fixed on the shaft wall 4 with two anchor bolts 3 disposed horizontally apart from each other separated by an interval.

According to the sixth embodiment, since the closed ends of the brackets 1 are slidably connected to the cage guide rail 110, and the cage guide rail 110 stands on the bottom floor 24 of the shaft 6, a bending moment working at a junction of the fastening plate 2D and the shaft wall 4, which is caused by a downward force applying to the cage guide rail 110, can be reduced.

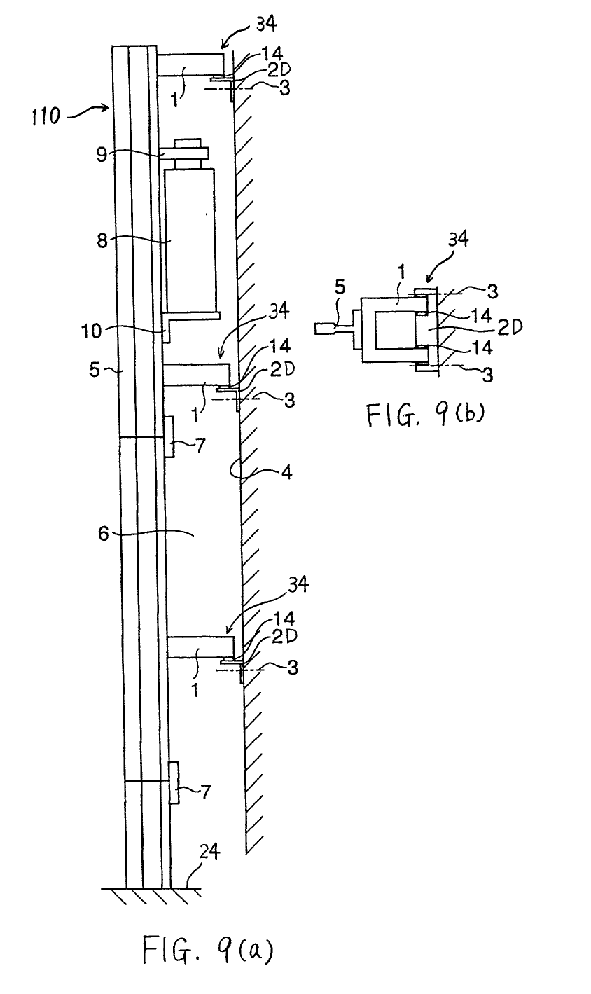

FIG. 9(a) is a side view of the mounting structure of a cage guide rail of a seventh embodiment of the present invention. FIG. 9(b) is a top view of the cage guide rail in FIG. 9(a).

In the seventh embodiment, a driving unit 8 is mounted one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 9(a)) composed of plural rails 5 is installed on a shaft wall 4. One of the cage guide rails 110, on which the driving unit 8 is mounted, is secured on the shaft wall 4 with rail support members 34 composed of brackets 1 having a U-shaped cross section, rubber sheets 14, and fastening plates 2D having an L-shaped cross section, and stands on the bottom floor 24 of the shaft 6. The other cage guide rail 110 is secured on the shaft wall 4 with the rail support members 30 shown in FIG. 2. Further, a pair of counter weight guide rails 111 (not shown in FIG. 9(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured with the support base 10 and the bracket 9.

Each of the rail support members 34 is composed of a bracket 1, two rubber sheets 14 and a fastening plate 2D. The closed end of the bracket 1 is secured to the cage guide rail 110 with rail clips (not shown), and opposite open ends thereof are connected to the fastening plate 2D via the rubber sheets 14 with bolts (not shown) or the like. The fastening plate 2D is fixed on the shaft wall 4 with two anchor bolts 3 horizontally separated from each other by an interval.

According to the seventh embodiment, since the open ends of the brackets 1 are connected to the fastening plates via the rubber sheets 14, and the cage guide rail 110 stands on the bottom 24 of the shaft 6, a bending moment working at a junction of the fastening plate 2D and the shaft wall 4, which is caused by a downward force applying to the cage guide rail 110, can be reduced.

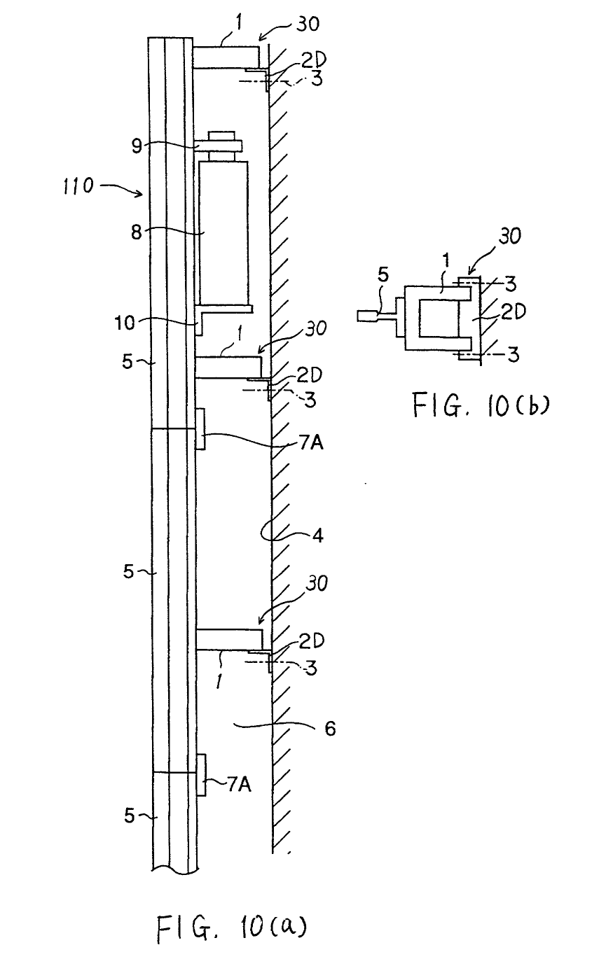

FIG. 10(a) is a side view of the mounting structure of a cage guide rail of an eighth embodiment of the present invention. FIG. 10(b) is a top view of the cage guide rail in FIG. 10(a).

In the eighth embodiment, a driving unit 8 is mounted on one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 10(a)) composed of plural rails 5 is installed on a shaft wall 4 with rail support members 30 composed of brackets 1 having a U-shaped cross section, and fastening plates 2D having an L-shaped cross section. The rails 5, which compose one of the cage guide rails 110 mounting on the driving unit 8, are connected together with connecting plates 7A made of highly damped steel such as ‘VIBLESS’ which is a brand name owned by NIPPON STEEL CORPORATION. A twin crystal alloy such as Mn—Cu alloy or Al—Zn alloy, which have relatively big internal friction, can be used as the highly damped steel. Further, composite materials such as fiber reinforced plastics can be substituted for the highly damped steel.

According to the eighth embodiment, the rails 5 mounting the driving unit 8 are connected together with connecting plates 7A made of highly damped steel, thereby preventing vibration, which is caused by the driving unit 8, from transferring to the shaft wall 4. Accordingly, uncomfortable noise and vibration are hardly generated in the building.

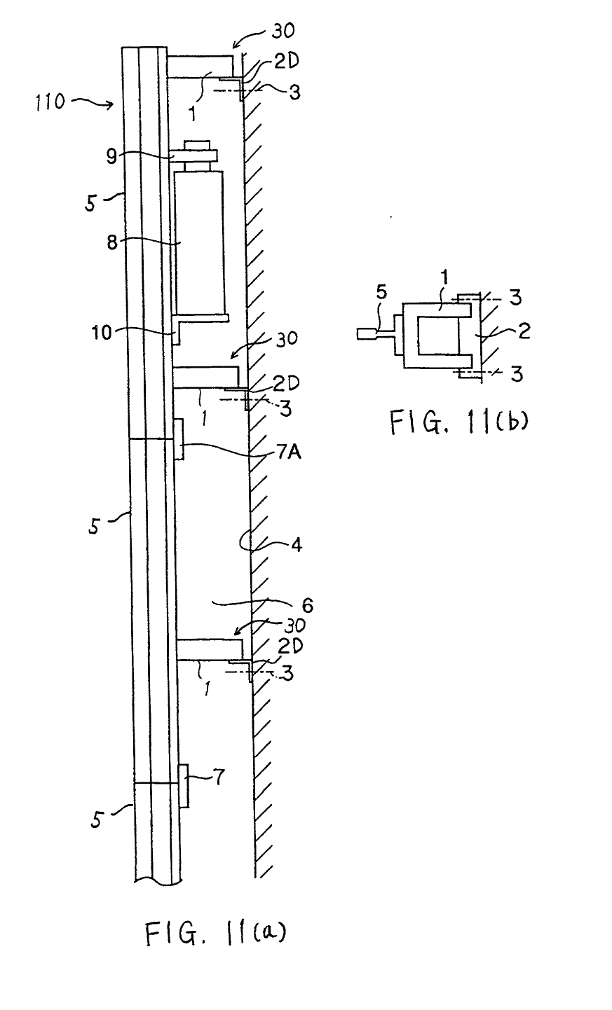

FIG. 11(a) is a side view of the mounting structure of a cage guide rail of a ninth embodiment of the present invention. FIG. 11(b) is a top view of the cage guide rail in FIG. 11(a).

Since the ninth embodiment modifies a part of the elevator of the eighth embodiment of the present invention, in the following description, only components different from the components explained in the eighth embodiment are described.

In the ninth embodiment, the connecting plate 7A, which is described in the eighth embodiment, is arranged to connect only the rail 5 mounting the driving unit 8 to take adjacent rail 5. That is, the connecting plate 7A located just below the driving unit 8 connects the rail 5 mounting the driving unit 8 and the next rail 5 together. The other rails 5 are connected with the connecting plates 7 shown in FIG. 2.

According to the ninth embodiment, only one of the rails 5 mounting the driving unit 8 is connected with the next rail 5 by the connecting plate 7A made of highly damped steel, thereby preventing with minimum structure vibration, which is caused by the driving unit 8, from being transferred to the shaft wall 4.

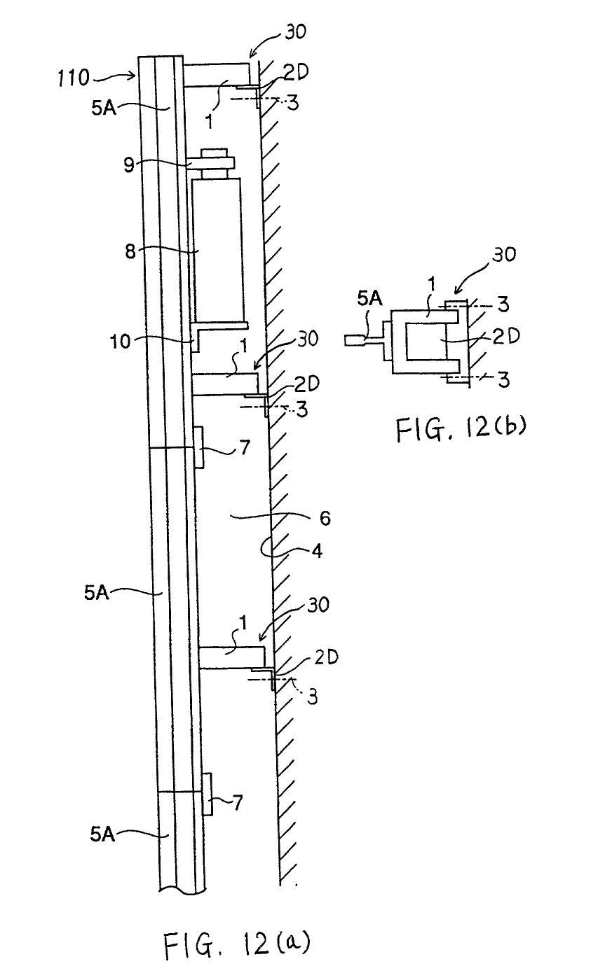

FIG. 12(a) is a side view of the mounting structure of a cage guide rail of a tenth embodiment of the present invention. FIG. 12(b) is a top view of the cage guide rail in FIG. 12(a).

In the tenth embodiment, a driving unit 8 is mounted on one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 12(a)) is installed on a shaft wall 4 with rail support members 30 composed of brackets 1 and fastening plates 2D. The cage guide rail 110 mounting the driving unit 8 is composed of rails 5A made of highly damped steel such as ‘VIBLESS’ which is a brand name owned by NIPPON STEEL CORPORATION.

According to the tenth embodiment, the cage guide rail 110 mounting the driving unit 8 is composed of the rails 5A made of highly damped steel, thereby preventing vibration, which is caused by the driving unit 8, from transferring to the shaft wall 4. Accordingly, uncomfortable noise and vibration are hardly generated in the building.

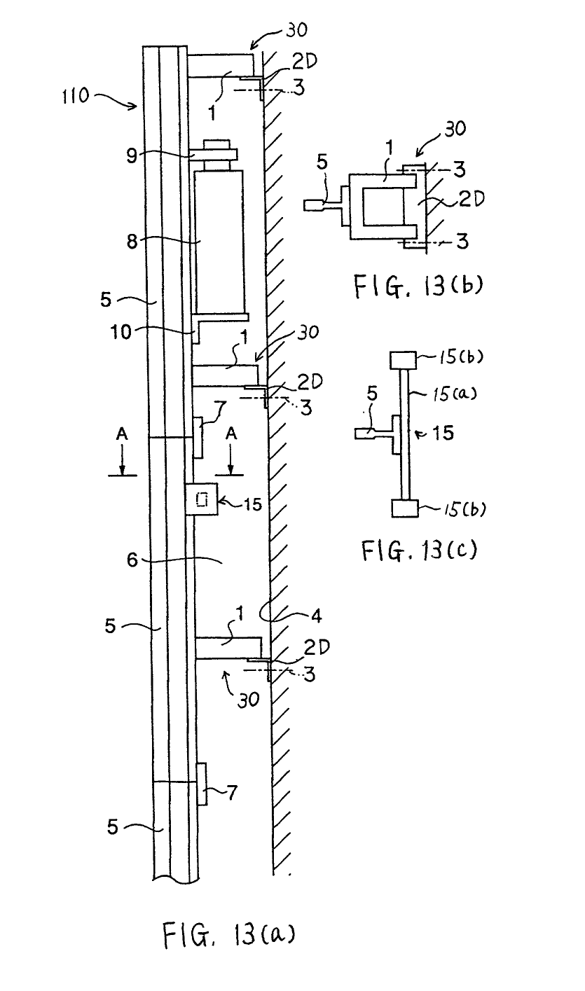

FIG. 13(a) is a side view of the mounting structure of a cage guide rail of an eleventh embodiment of the present invention. FIG. 13(b) is a top view of the cage guide rail in FIG. 13(a). FIG. 13(c) is a view of a damper member in the direction of the arrows A in FIG. 13(a).

In the eleventh embodiment, a driving unit 8 is mounted on one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 13(a)) is installed on a shaft wall 4 with rail support members 30 composed of brackets 1 and fastening plates 2D. A damper member 15 is provided on the cage guide rail 110 mounting the driving unit 8, and attached adjacent to the driving unit 8. The damper unit 15, composed of a bar 15(a) and two weights 15(b) mounted on opposite ends of the bar 15(a), absorbs a predetermined frequency of vibration. The weight of the weights 15(b) and the length of the bar 15(a) are determined in accordance with a frequency of the vibration of the cage guide rail 110.

According to the eleventh embodiment, the damper member 15 is provided on the cage guide rail 110 mounting the driving unit 8, thereby preventing vibration, which is caused by the driving unit 8, from transferring to the shaft wall 4. Accordingly, uncomfortable noise and vibration are damped and hardly generated in the building.

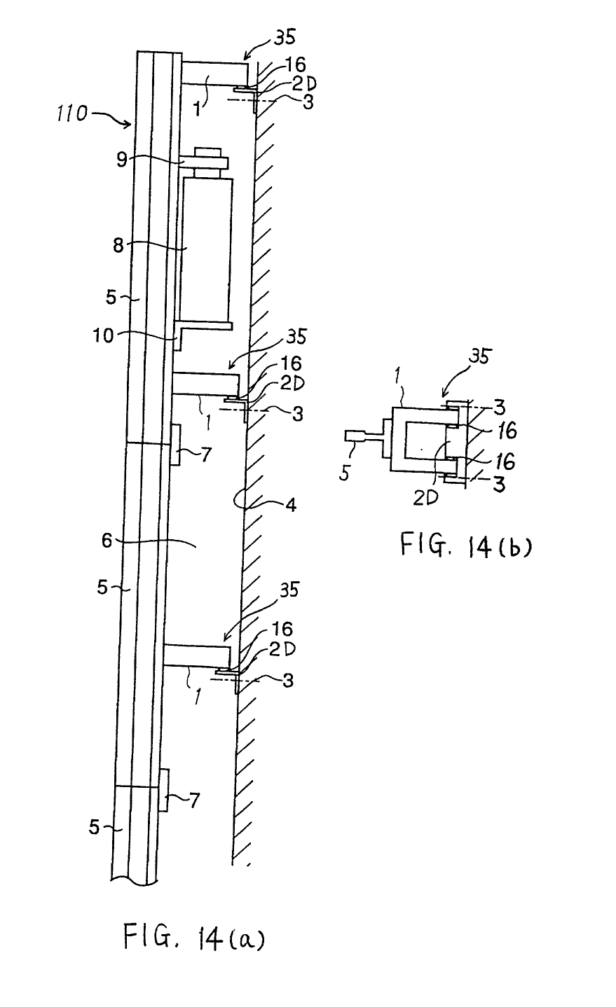

FIG. 14(a) is a side view of the mounting structure of a cage guide rail of a twelfth embodiment of the present invention. FIG. 14(b) is a top view of the cage guide rail in FIG. 14(a).

In the twelfth embodiment, a driving unit 8 is mounted on one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 14(a)) composed of plural rails 5 is installed on a shaft wall 4. One of the cage guide rails 110, which mounts the driving unit 8, is secured on the shaft wall 4 with rail support members 35 composed of brackets 1 having a U-shaped cross section, rubber sheets 16, and fastening plates 2D having an L-shaped cross section. The other cage guide rail 110 is secured on the shaft wall 4 with the rail support members 30 shown in FIG. 2. Further, a pair of counter weight guide rails 111 (not shown in FIG. 14(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

A support base 10 having an L-shaped cross section and a bracket 9 is provided at one of the cage guide rails 110, and a driving unit 8, which includes a traction sheave (not shown) for driving cables 103 and moving the cage 101 up and down, is secured with the support base 10 and the bracket 9.

Each of the rail support members 35 is composed of a bracket 1, a pair of rubber sheets 16 and a fastening plate 2D. The closed end of the bracket 1 is secured to the cage guide rail 110, with rail clips (not shown), and the open ends thereof are connected to the fastening plate 2D via the rubber sheets 16 with bolts (not shown) or the like. The fastening plate 2D is fixed on the shaft wall 4 with two anchor bolts 3 disposed each other with an interval in the horizontal direction.

According to the twelfth embodiment, the open ends of the brackets 1 are connected to the fastening plates 2D via the rubber sheets 16, thereby preventing vibration, which is caused by the driving unit 8, from transferring to the shaft wall 4. Accordingly, uncomfortable noise and vibration are hardly generated in the building.

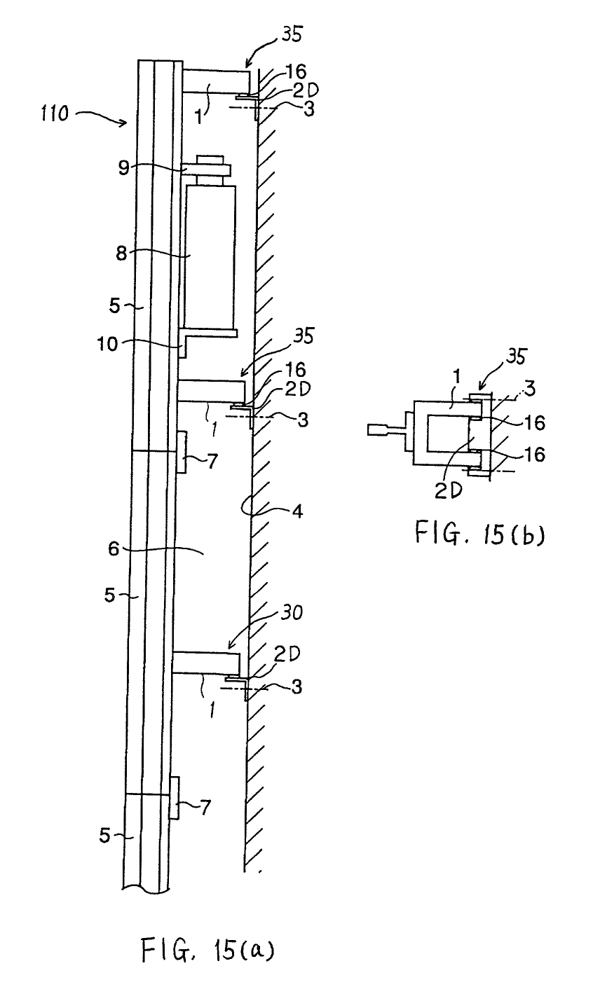

FIG. 15(a) is a side view of the mounting structure of a cage guide rail of a thirteenth embodiment of the present invention. FIG. 15(b) is a top view of the cage guide rail in FIG. 15(a).

Since the thirteenth embodiment modifies a part of the elevator of the twelfth embodiment of the present invention, in the following description, only components different from the components explained in the twelfth embodiment are described.

In the thirteenth embodiment, the support members 35 are connected only to the rail 5 mounting the driving unit 8. That is, the rubber sheets 16 are provided on the fastening plates 2D located adjacent to upper and lower sides of the driving unit 8 in the same way as in the twelfth embodiment. The other rails 5 are secured with the rail support members 30 shown in FIG. 2.

According to the thirteenth embodiment, only one of the rails 5 mounting the driving unit 8 is secured with the rail support members 35, thereby preventing vibration caused by the driving unit 8 from transferring to the shaft wall 4.

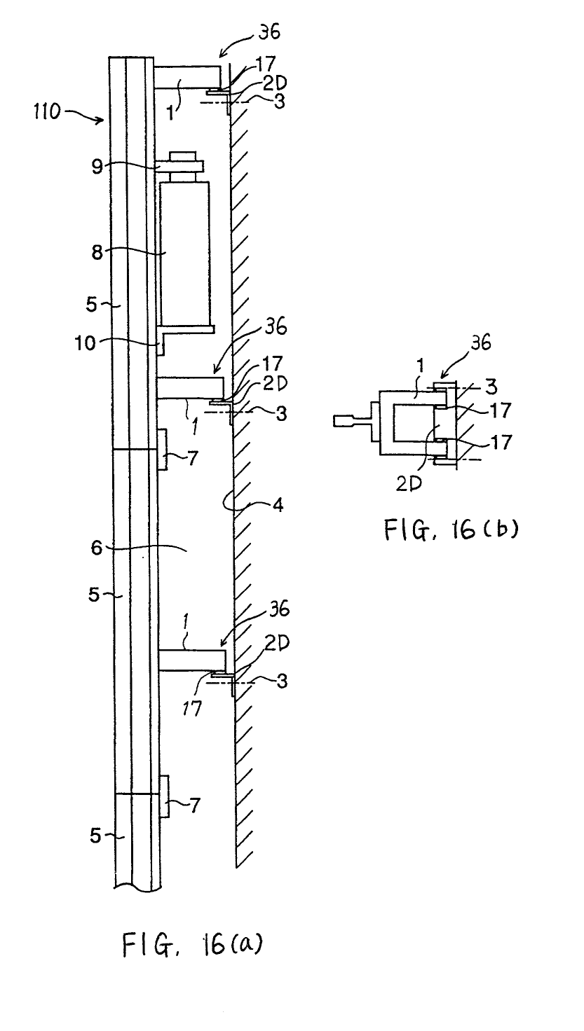

FIG. 16(a) is a side view of the mounting structure of a cage guide rail of a fourteenth embodiment of the present invention. FIG. 16(b) is a top view of the cage guide rail in FIG. 16(a).

In the fourteenth embodiment, a driving unit 8 is mounted on one of the cage guide rails 110, and the mounting structure of the cage guide rail 110 is improved in comparison with the mounting structure of the cage guide rail 110 shown in FIG. 2.

Similar to FIGS. 1 and 2, a pair of cage guide rails 110 (only one is shown in FIG. 16(a)) composed of plural rails 5 is installed on a shaft wall 4. One of the cage guide rails 110, which mounts the driving unit 8, is secured on the shaft wall 4 with rail support members 36 composed of brackets 1 having a U-shaped cross section, damping sheets 17 made of highly damped steel, and fastening plates 2D having an L-shaped cross section. The other cage guide rail 110 is secured on the shaft wall 4 with the rail support members 30 shown in FIG. 2. Further, a pair of counter weight guide rails 111 (not shown in FIG. 16(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

Each of the rail support members 36 is composed of a bracket 1, two damping sheets 17 and a fastening plate 2D. The closed end of the bracket 1 is secured to the cage guide rail 110 with rail clips (not shown), and the open ends thereof are connected to the fastening plate 2D via the damping sheets 17 with bolts (not shown) or the like. The fastening plate 2D is fixed on the shaft wall 4 with two anchor bolts 3 horizontally separated from each other by an interval.

According to the fourteenth embodiment, the open ends of the brackets 1 are connected to the fastening plates 2D via the damping sheets 17, thereby preventing vibration, which is caused by the driving unit 8, from transferring to the shaft wall 4. Accordingly, uncomfortable noise and vibration are hardly transferred to the building.

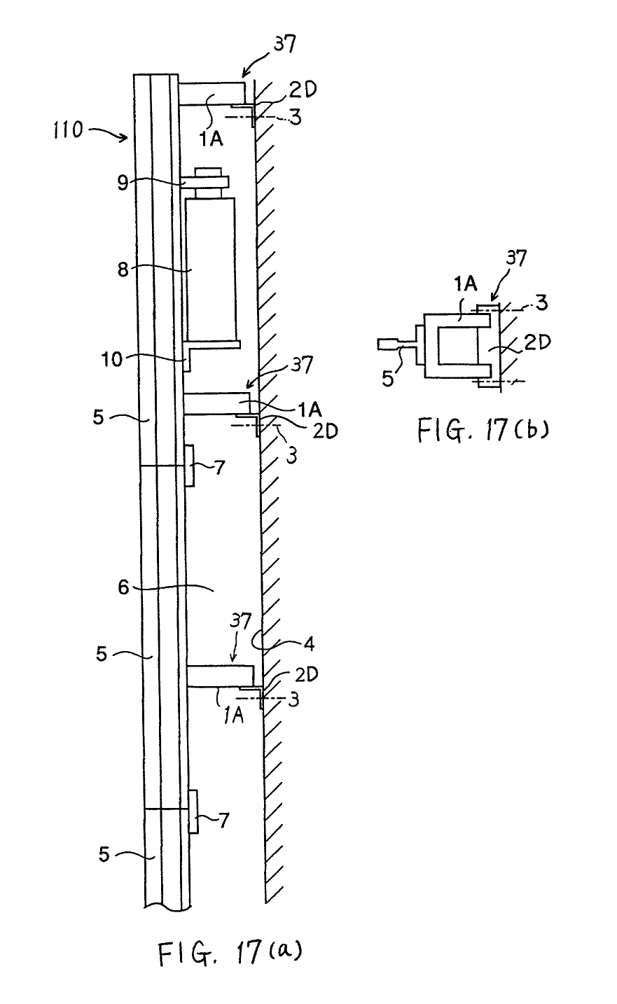

FIG. 17(a) is a side view of the mounting structure of a cage guide rail of a fifteenth embodiment of the present invention. FIG. 17(b) is a top view of the cage guide rail in FIG. 17(a).

In the fifteenth embodiment, a driving unit 8 is mounted one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 17(a)) composed of plural rails 5 is installed on a shaft wall 4. One of the cage guide rails 110, which mounts the driving unit 8, is secured on the shaft wall 4 with rail support members 37 composed of brackets 1A made of highly damped steel and fastening plates 2D. The other cage guide rail 110 is secured on the shaft wall 4 with the rail support members 30 shown in FIG. 2. Further, a pair of counter weight guide rails 111 (not shown in FIG. 16(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

According to the fifteenth embodiment, the brackets 1A are made of highly damped steel, thereby preventing vibration caused by the driving unit 8 from transferring to the shaft wall 4. Accordingly, uncomfortable noise and vibration are hardly generated in the building. The fastening plates 2D can be made of highly damped steel. In this case, the brackets 1A can be substituted for the brackets 1 made of ordinary steel.

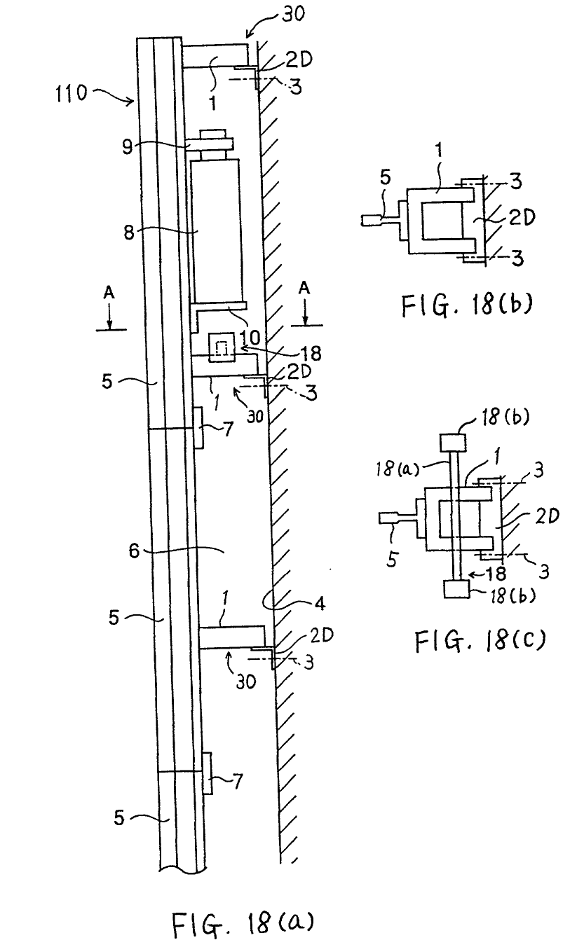

FIG. 18(a) is a side view of the mounting structure of a cage guide rail of a sixteenth embodiment of the present invention. FIG. 18(b) is a top view of the cage guide rail in FIG. 18(a). FIG. 18(c ) is a view of a damper unit in the direction of the arrows A in FIG. 18(a).

In the sixteenth embodiment, a driving unit 8 is mounted on one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 18(a)) is installed on a shaft wall 4 with rail support members 30 composed of brackets 1 and fastening plates 2D. An active damper unit 18 is provided on one of the brackets 1 supporting the rail 5 mounting the driving unit 8, and attached adjacent to the driving unit 8. The damper unit 18, composed of a bar 18(a) and two weights 18(b) mounted on opposite ends of the bar 18(a), absorbs a predetermined frequency of vibration. The weight of the weights 18(b) and the length of the bar 18(a) are determined in accordance with a frequency of vibration of the cage guide rail 110.

According to the sixteenth embodiment, the damper member 18 is provided on one of the brackets 1 adjacent to the driving unit 8, thereby preventing vibration caused by the driving unit 8 from transferring to the shaft wall 4. Accordingly, uncomfortable noise and vibration are hardly generated in the building.

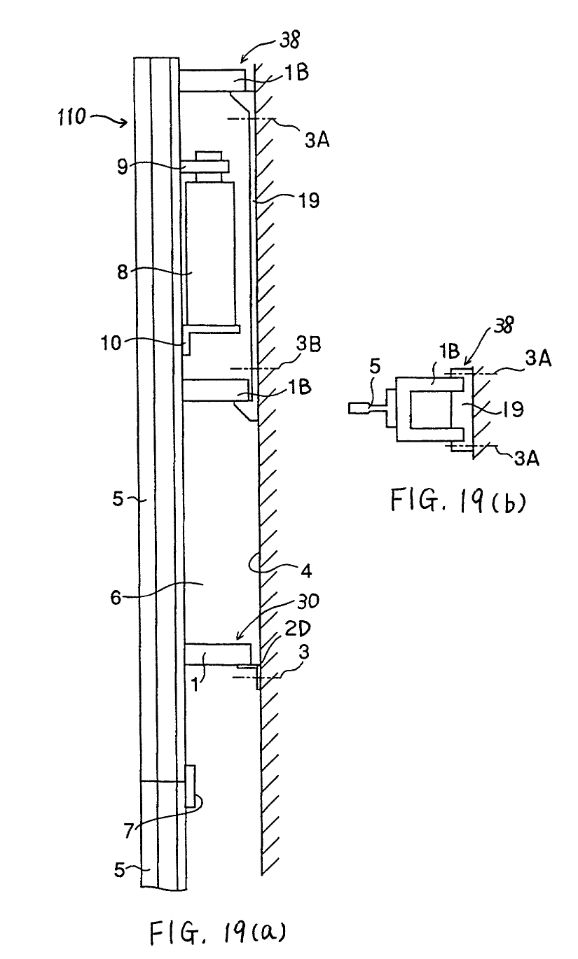

FIG. 19(a) is a side view of the mounting structure of a cage guide rail of a seventeenth embodiment of the present invention. FIG. 19(b) is a top view of the cage guide rail in FIG. 19(a).

In the seventeenth embodiment, a driving unit 8 is mounted on one of the cage guide rails 110, and the structure of the cage guide rail 110 is improved in comparison with the structure of the cage guide rail 110 shown in FIG. 2.

Similar to FIGS. 1 and 2, a pair of cage guide rails 110 (only one is shown in FIG. 19(a)) composed of plural rails 5 is installed on a shaft wall 4. One of the cage guide rails 110, which mounts the driving unit 8, is secured on the shaft wall 4 with rail support members 30 composed of brackets 1 and fastening plates 2D, and rail support member 38 composed of two brackets 1B and a coupling plate 19 connecting the brackets 1B together. The brackets 1B are disposed at upper and lower nearest sides of the driving unit 8. The coupling plate 19 is secured on the shaft wall 4 by upper and lower pairs of anchor bolts 3A and 3B which are respectively separated by an interval in the horizontal direction. The other cage guide rail 110 is secured on the shaft wall 4 with the rail support members 30 shown in FIG. 2. Further, a pair of counter weight guide rails 111 (not shown in FIG. 19(a)) is installed on the shaft wall 4 with the rail support members 30 shown in FIG. 2. The cage 101 and the counterweight 102 are respectively guided by the cage guide rails 110 and the counter weight guide rails 111, and hanged by cables 103 as shown in FIG. 1.

According to the seventeenth embodiment, since two brackets 1B adjacent to the driving unit 8 are coupled by the coupling plate 19, and the coupling plate 19 is secured on the shaft wall 4 by two pairs of anchor bolts 3A and 3B, the driving unit 8 can be surely supported.

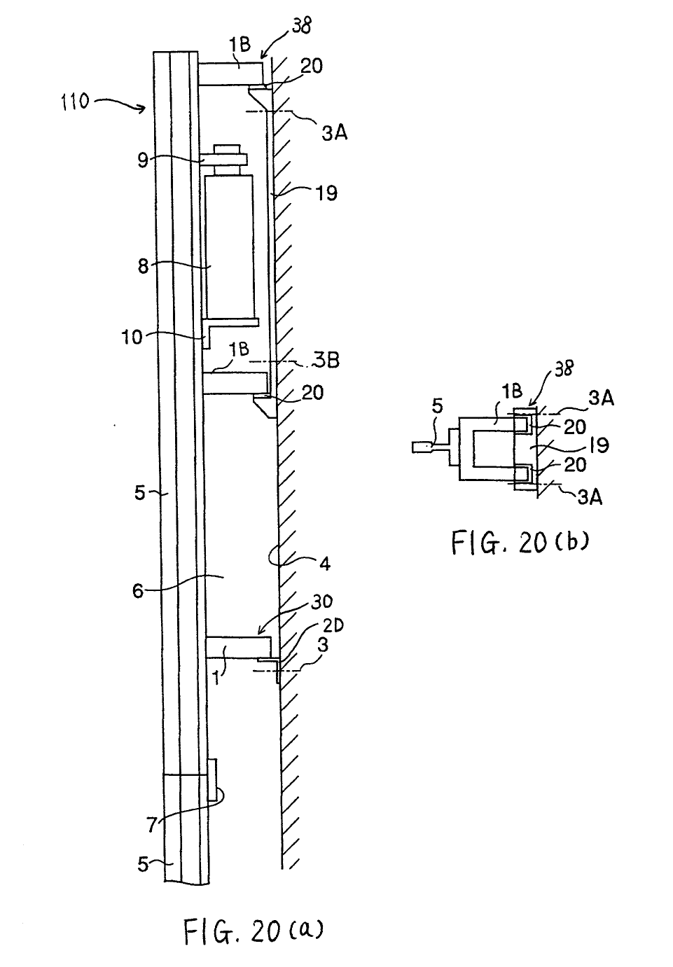

FIG. 20(a) is a side view of the mounting structure of a cage guide rail of an eighteenth embodiment of the present invention. FIG. 20(b) is a top view of the cage guide rail in FIG. 20(a).

Since the eighteenth embodiment modifies a part of the elevator of the seventeenth embodiment of the present invention, in the following description, only components different from the components explained in the seventeenth embodiment are described.

In the eighteenth embodiment, rubber sheets 20 are laid between the brackets 1B and the coupling plate 19.

According to the eighteenth embodiment, the brackets 1B are connected with the coupling plate 19 via the rubber sheets 20 with bolts (not shown) or the like, thereby preventing vibration caused by the driving unit 8 from transferring to the shaft wall 4, in addition to the effects of the seventeenth embodiment.

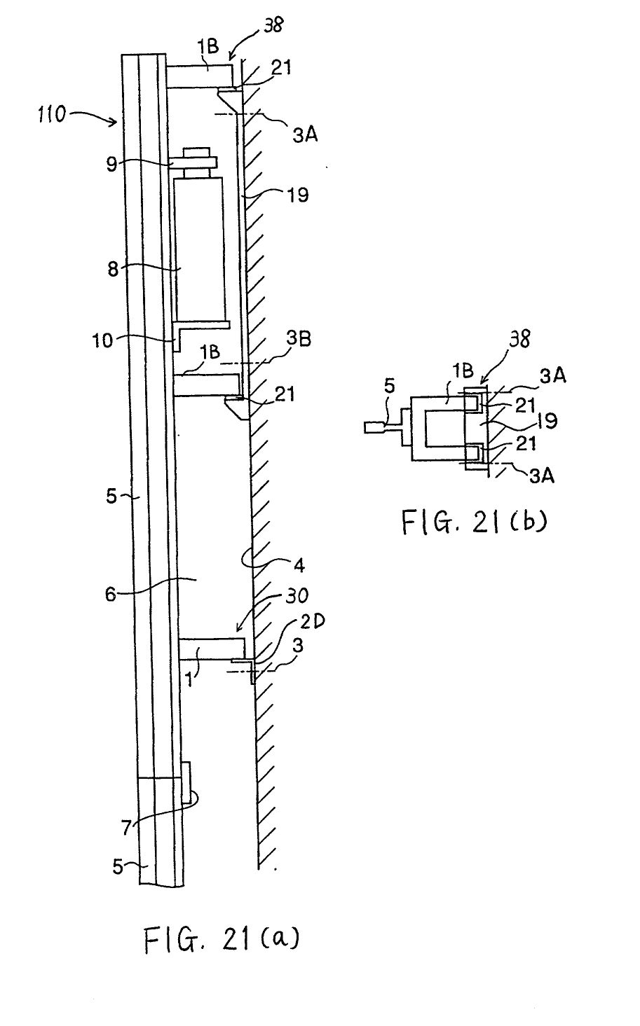

FIG. 21 (a) is a side view of the mounting structure of a cage guide rail of a nineteenth embodiment of the present invention. FIG. 21 (b) is a top view of the cage guide rail in FIG. 21(a).

Since the nineteenth embodiment modifies a part of the elevator of the eighteenth embodiment of the present invention, in the following description, only components different from the components explained in the eighteenth embodiment are described.

In the nineteenth embodiment, damping steel sheets 21, which is made of highly damped steel, are substituted for the rubber sheets 20 of the eighteenth embodiment.

According to the nineteenth embodiment, the brackets 1B are connected with the coupling plate 19 via the damping steel sheets 21 with bolts (now shown) or the like, thereby preventing vibration caused by the driving unit 8 from transferring to the shaft wall 4, in addition to the effects of the seventeenth embodiment.

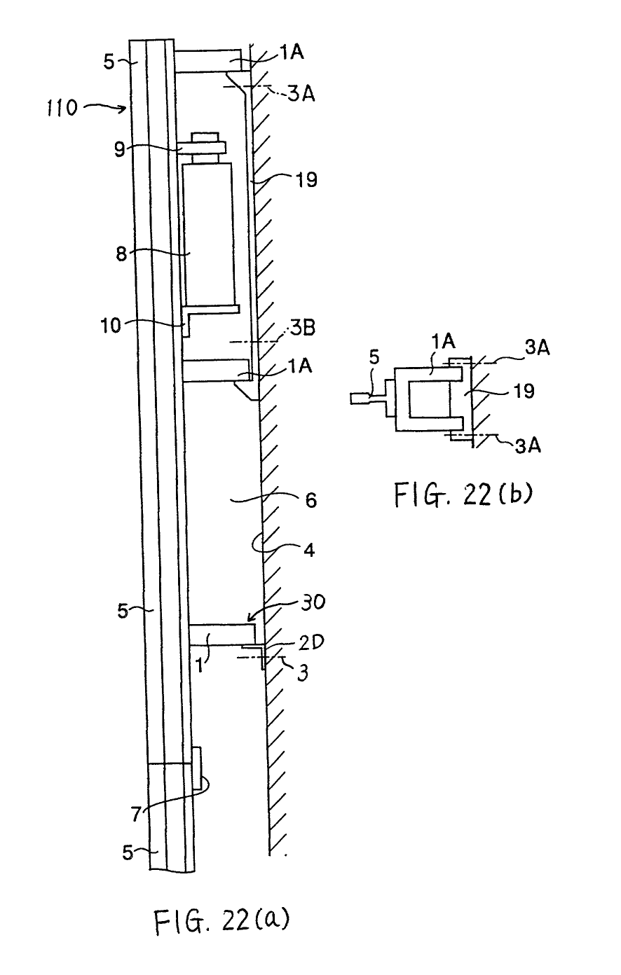

FIG. 22(a) is a side view of the mounting structure of a cage guide rail of a twentieth embodiment of the present invention. FIG. 22(b) is a top view of the cage guide rail in FIG. 22(a).

Since the twentieth embodiment modifies a part of the elevator of the seventeenth embodiment of the present invention, in the following description, only components different from the components explained in the seventeenth embodiment are described.

In the twentieth embodiment, the brackets 1A, which is made of highly damped steel, are substituted for the brackets 1B of the seventeenth embodiment in FIG. 19(a).

According to the twentieth embodiment, the cage guide rail 110 is supported by the brackets 1A made of highly damped steel and connected with the coupling plate 19, thereby preventing vibration caused by the driving unit 8 from transferring to the shaft wall 4, in addition to the effects of the seventeenth embodiment.

The coupling plate 19 can also be made of highly damped steel. In this case, the brackets 1A can be substituted for the brackets 1B made of ordinary steel.

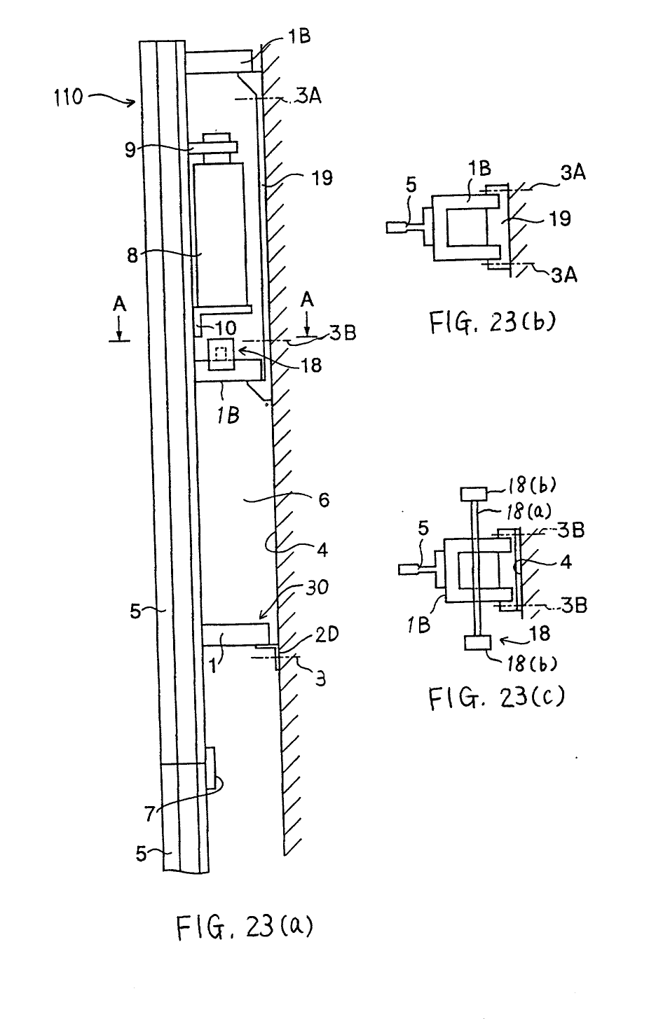

FIG. 23(a) is a side view of the mounting structure of a cage guide rail of a twenty first embodiment of the present invention. FIG. 23(b) is a top view of the cage guide rail in FIG. 23 (a). FIG. 23(c) is a view of a damper member in the direction of the arrows A in FIG. 23(a).

Since the twenty first embodiment modifies a part of the elevator of the seventeenth embodiment of the present invention, in the following description, only components different from the components explained in the seventeenth embodiment are described.

In the twenty first embodiment, an active damper unit 18 is provided on one of the brackets 1B connected by the coupling plate 19. The damper unit 18, composed of a bar 18(a) and two weights 18(b) mounted on opposite ends of the bar 18(a), absorbs a predetermined frequency of vibration. The weight of the weights 18(b) and the length of the bar 18(a) are determined in accordance with a frequency of the vibration of the cage guide rail 110.

According to the twenty first embodiment, the damper member 18 is provided on one of the brackets 1B adjacent to the driving unit 8, thereby preventing vibration caused by the driving unit 8 from transferring to the shaft wall 4, in addition to the effects of the seventeenth embodiment.

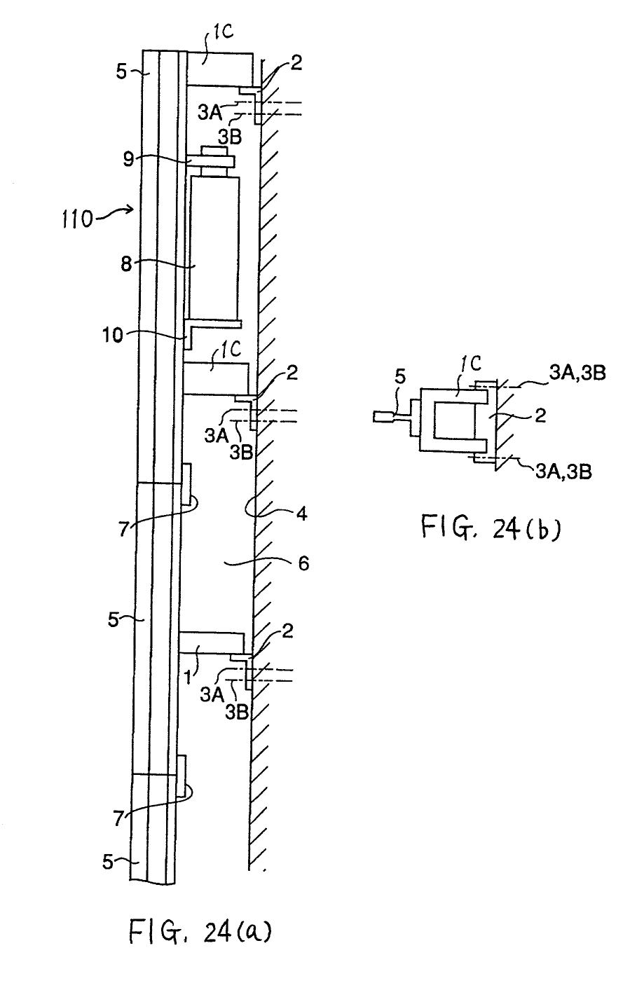

FIG. 24(a) is a side view of the mounting structure of a cage guide rail of a twenty second embodiment of the present invention. FIG. 24(b) is a top view of the cage guide rail in FIG. 24(a).

Since the twenty second embodiment modifies a part of the elevator of the first embodiment of the present invention, in the following description, only components different from the components explained in the first embodiment are described.

In the twenty second embodiment, upper and lower brackets 1C are substituted for the two brackets 1 adjacent to upper and lower sides of the driving unit 8. In this embodiment, the flexural rigidity of the brackets 1C is stronger than that of the brackets 1. A bending moment working at a junction of the fastening plates 2 and the shaft 4 is reduced the farther a bracket 1 is away from the driving unit 8. That is, in FIG. 24(a), the largest bending moment works on the top of the brackets 1C.

According to the twenty second embodiment, since the flexural rigidity of the brackets 1C adjacent to upper and lower sides of the driving unit 8 is stronger than that of the brackets 1, the driving unit 8 can be surely supported with minimum structure and low cost.

In the above described embodiments, although the driving unit 8 shown mounted on the cage guide rail 110, it should be understood that the driving unit 8 can be mounted on the counter weight guide rail 111. Further, although the anchor bolts 3, 3A and 3B are used as a securing member, ordinary bolts or welding can be adopted in case that the shaft 6 is constructed with a steel frame.

Various modifications and variations are possible in light of the above teachings. Therefore, it is to be understood that within the scope of the appended claims, the present invention may be practiced otherwise than as specifically described herein.

What is claimed as new and desired to be secured by Letters Patent of the United States is:

1. An elevator comprising:
a movable unit configured to ascend and descend in an elevator shaft;
a guide rail installed on said elevator shaft via a plurality of rail support members and configured to guide said movable unit;
a cable configured to hang said movable unit;
a driving unit mounted on said guide rail and configured to move said movable unit up and down by driving said cable; and
at least one of said rail support members fixed to a wall of said shaft by means of at least two securing members separated from each other by an interval in the vertical direction.

2. The elevator as recited in claim 1, wherein:
at least one of said rail support members adjacent to said driving unit is fixed by said at least two securing members.

3. The elevator as recited in claim 1 or 2, wherein said securing members comprise upper and lower pairs of anchor bolts, each pair of said anchor bolts being separated by an interval in the horizontal direction.

4. The elevator as recited in claim 3 wherein:
W is a load applied to one end of said rail support members at which said guide rail is connected,
h is a distance between said shaft wall and said guide rail,
f is a maximum permissible tensile strength of an uppermost of said securing members,
n is the number of lines of said securing members,
L is a distance of said interval, and
(Wh)/(2fn)≦L≦(Wh)/(fn).

5. An elevator comprising:
a movable unit configured to ascend and descend in an elevator shaft;
a guide rail installed on said elevator shaft via a plurality of rail support members and configured to guide said movable unit;
a cable configured to hang said movable unit;
a driving unit mounted on said guide rail and configured to move said movable unit up and down by driving said cable; and
supporting means for attenuating a bending moment existing at at least one of said support members.

6. The elevator as recited in claim 5, wherein:
said supporting means are attached to at least said rail support members adjacent to said driving unit.

7. The elevator as recited in claim 5, wherein said supporting means comprise:
pivot member connecting a respective support member to said guide rails.

8. An elevator comprising:
a movable unit configured to ascend and descend in an elevator shaft;
a guide rail installed on said elevator shaft via a plurality of rail support members and configured to guide said movable unit;
a cable configured to hang said movable unit;
a driving unit mounted on said guide rail and configured to move said movable unit up and down by driving said cable; and
a beam fixed on said elevator shaft with an upper end of said guide rail secured to said beam.

9. An elevator comprising:
a movable unit configured to ascend and descend in an elevator shaft;
a guide rail installed on said elevator shaft via a plurality of rail support members and configured to guide said movable unit;
a cable configured to hang said movable unit; and
a driving unit mounted on said guide rail and configured to move said movable unit up and down by driving said cable;
said guide rail being slidably supported by said rail support members and standing on the bottom of said shaft.

10. An elevator comprising:
a movable unit configured to ascend and descend in an elevator shaft;
a guide rail installed on said elevator shaft via a plurality of rail support members and configured to guide said movable unit;
a cable configured to hang said movable unit;
a driving unit mounted on said guide rail and configured to move said movable unit up and down by driving said cable; and
an elastic member coupled to respective of said rail support members and configured to attenuate vibration caused by said driving unit.

11. An elevator comprising:
a movable unit configured to ascend and descend in an elevator shaft;
a guide rail installed on said elevator shaft via a plurality of rail support members and configured to guide said movable unit;
a cable configured to hang said movable unit;
a driving unit mounted on said guide rail and configured to move said movable unit up and down by driving said cable; and
a damper member attached to at least one of said rail support members or said guide rail and configured to attenuate vibration caused by said driving unit.

12. The elevator as recited in claim 11, wherein:
said damper member is attached to at least said rail support members adjacent to said driving unit or to said guide rail near said driving unit.

13. The elevator as recited in claim 11, wherein:
said guide rail comprises a plurality of rails being connected together by connecting plates; and
said damper member comprises at least one of said connecting plates made of highly damped steel.

14. The elevator as recited in claim 11, wherein:
said guide rail comprises a plurality of rails connected together; and
at least one said rail is made of highly damped steel.

15. The elevator as recited in claim 11, wherein:
said damper member comprises an active damper.

16. The elevator as recited in claim 11, wherein:
each of said rail support members comprises a bracket connected at one end thereof to said guide rail, and a plate secured at one end thereof to a wall of said elevator shaft and at another end thereof to another end of said bracket; and
said damper member comprises a highly damped steel disposed between said bracket and said plate.

17. The elevator as recited in claim 11, wherein:
each of said rail support members comprises a bracket connected at one end thereof to said guide rail, and a plate secured at one end thereof to a wall of said elevator shaft and at another end thereof to another end of said bracket; and
at least one of said bracket and said plate is made of highly damped steel.

18. The elevator as recited in claim 11, wherein:
each of said rail support members comprise a bracket connected at one end thereof to said guide rail, and a plate secured at one end thereof to said shaft wall and at another end thereof to another end of said bracket; and
said damper member comprises an active damper attached to the bracket or the plate of at least one of said rail support members.

19. An elevator comprising:
a movable unit configured to ascend and descend in an elevator shaft;
a guide rail installed oil said elevator shaft via a plurality of rail support members and configured to guide the movable unit;
a cable configured to hang said movable unit;
a driving unit mounted on said guide rail and configured to move said movable unit up and down by driving said cable;
a coupling member configured to connect at least two rail support members adjacent to said driving unit together; and
said coupling member being secured to a wall of said elevator shaft by at least two securing members separated from each other by an interval in the vertical direction.

20. The elevator as recited in claim 19, further comprising:
a damper member attached to one of said rail support members connected together by said coupling member and configured to attenuate vibration caused by said driving unit.

21. The elevator as recited in claim 19, further comprising:
an elastic member disposed at a coupling portion of one of said rail support members and said coupling member.

22. The elevator as recited in claim 19, further comprising:
highly damped steel lying at a coupling portion of one of said rail support members and said coupling member.

23. The elevator as recited in claim 19, wherein:
at least one of said coupling member and said rail support members connected together by said coupling member is made of highly damped steel.

24. The elevator as recited in claim 20, wherein:
said damper member comprises an active damper.

25. An elevator comprising:
a movable unit configured to ascend and descend in an elevator shaft;
a guide rail installed on said elevator shaft via a plurality of rail support members and configured to guide said movable unit;
a cable configured to hang said movable unit; and
a driving unit mounted on said guide rail and configured to move said movable unit up and down by driving said cable;
wherein flexural rigidity of said rail support members adjacent to said driving unit is stronger than that of the rest of said rail support members.
